(19) United States
(12) Patent Application Publication
(10) Pub. No.: US 2026/0177418 A1
(43) Pub. Date: Jun. 25, 2026

(54) METHOD OF MANUFACTURING A BASE BODY OF A WEIGHING SENSOR AND BASE BODY

(71) Applicant: Sartorius Lab Instruments GmbH & Co. KG, Goettingen (DE)

(72) Inventors: Lars BORNEMANN, Goettingen (DE); Matthias GEISLER, Goettingen (DE); Winfried GRAF, Goettingen (DE)

(21) Appl. No.: 19/124,534

(22) PCT Filed: Oct. 11, 2023
(86) PCT No.: PCT/EP2023/078251

§ 371 Date: Apr. 25, 2025

(30) Foreign Application Priority Data
Oct. 28, 2022 (DE) 10 2022 128 780.7

(51) Int. Cl. G01G 21/23; A63B 21/072

(52) U.S. Cl. CPC G01G 21/23; A63B 21/0726

(57) ABSTRACT

A method of manufacturing a base body of a weighing sensor of a high-precision balance in which a base body is machined out of a monolithic metal block and has at least one arm which is hinged to the rest of the metal block via integral bending spring joints in the form of thin spots. The base body is then acted upon with a chemical solution at least at the bending spring joints to cause a material removal at these points. Furthermore, a base body manufactured by this method is presented.

### FIELD OF THE INVENTION

The invention relates to a method of manufacturing a monolithic or partially monolithic base body of a weighing sensor and to a base body manufactured using the method according to the invention.

### BACKGROUND

In particular, the invention relates to a method of manufacturing a monolithic or partially monolithic base body for a high-resolution balance with a resolution of up to 0.0001 mg and several millions of weighing steps, i.e. for example a high-precision balance.

These balances usually work according to the principle of electromagnetic force compensation, i.e. the weight force is converted into an electrical signal by a force sensor. The central element of such a high-precision balance is a usually monolithic base body, which is milled out of a block of material and has a section referred to as the load sensor, which is linked to the rest of the base body by one or more arms, also referred to as transmission levers. An alternative to such a monolithic base body is a so-called partially monolithic base body, which is composed of a few monolithic parts. The arms form, for example, one or more parallelogram guides. The force to be measured is transmitted via one or more arms and compensated by means of electromagnetic force compensation (EMF) through a position-controlled coil. In a monolithic or partially monolithic base body, the corresponding arms of the parallelogram guide are hinged to the rest of the metal block by means of bending spring joints in the form of thin spots. Further parts of the base body are also coupled via bending spring joints and may be used to reduce disruptive effects caused by off-center loads by adjustment, or they may be used to transmit force between sections of the base body (e.g. levers and shell couplers) in the form of so-called coupling elements. This means that all parts and bending spring joints are machined, in particular milled, out of the metal block blank in one piece, and all these components merge into each other in one piece. This applies to both monolithic and partially monolithic base bodies. What these monolithic or partially monolithic base bodies have in common is that each arm and thus also the two bending spring joints of the arm merge in one piece into each other and are originally machined from the same part, and likewise merge in one piece into the respectively adjacent part of the metal block and are also machined out of the same metal block along therewith. This means that the arms, the joints and the directly adjacent parts of the metal block are made of the same material and only of a single material. They are not composed, glued or welded together from several parts. The invention relates to such a monolithic base body.

This system of producing as many components of the weighing system as possible from a single blank results in a very complex three-dimensional geometry.

Besides milling, there are other technologies, such as eroding and grinding, which may be used for production. The weighing performance of the base body which can be achieved later with regard to changing environmental influences (e.g. temperature) depends on the accuracy and dimensional stability of the arms, but especially of the bending spring joints and the absence of stress in the material. These bending spring joints have thicknesses of at most a few tenths of a millimeter, which is very demanding for manufacturing, especially since the workpiece-side supporting force during milling is negligible at such thicknesses. Manufacturing can therefore only function in these areas of the monolith if the feed rate and the milling forces in the area of the bending spring joints are very small, which in turn slows down the manufacturing process and increases the costs and the risk of rejects.

### SUMMARY

The object of the invention is to create a method of manufacturing a monolithic or partially monolithic base body of a weighing sensor which enables faster production with greater process reliability, at least achieves the previous production accuracy and, above all, improves the weighing behavior of a base body manufactured in this way.

This is achieved by the invention through the following steps:
A) a base body or part of a base body is machined, in particular milled, out of a monolithic metal block, which has at least one arm which is connected to the rest of the metal block via integral bending spring joints in the form of thin spots, and
B) the produced base body is exposed at least at the bending spring joints to a chemical solution, which causes a material removal at the bending spring joints.

Consequently, in step A), at least one arm, the bending spring joints adjacent thereto and the so-called rest of the metal block are machined out of the metal block. The bending spring joints are made of the same material as the rest of the base body, since like the arms, they are machined out of a monolithic metal block which represents the initial body for these sections. In the method according to the invention, no current is applied to the workpiece during the chemical treatment thereof, so it is a purely chemical method and not an electrochemical removal process. More specifically, this means that no electrical contact is required on the base body.

It has been found that internal stresses in the material cause disturbing long-term effects in the area of the bending spring joints, which are not always the same (process variation) and thus lead to a negative influence on the weighing behavior. Such stresses can be generated by the machining process, but also by the manufacture of the blank during extrusion or rolling. Tests have shown that these stresses can be significantly reduced by the slight chemical removal at the outer layers of the material.

The stresses in the rest of the metal block are also reduced. These are caused by the extrusion or rolling of the starting material. Since greatly reduced mechanical or, more generally, external forces are exerted on the base body, especially in the area of the bending spring joints, the chemical removal has only positive effects.

The reduced roughness resulting in the area of the arms or in the rest of the metal block also ensures a more reproducible behavior of the load cell.

A further effect which in particular has a positive influence on the manufacturing speed and the reject rates, results from the fact that, due to the chemical removal of material, the bending spring joints no longer have to be previously made as thin as before during removal or milling. This is an enormous advantage which has a positive effect on the working speed. Base bodies having the same final dimensions can thus be produced, but which, when processed by ablation, in particular milling, have a different, i.e. greater, thickness than before, because these bodies are still chemically reworked. Alternatively, smaller thicknesses than before can be achieved by the chemical processing.

The entire base body may be brought into contact with the chemical solution, e.g. be dipped into the solution, or only a partial area thereof. This depends on the geometry of the respective base body and on which areas are to be positively modified by the chemical solution.

Alternatively, the base body is sprayed with the solution, either completely or only in sections.

The chemical solution is preferably an etchant, i.e. it etches the surface at least in the area of the bending spring joints.

In step B), at least 2 to 50 μm of material should be removed on the flat sides of the bending spring joints. This means that the thinnest point is made twice as thin, i.e. 4 to 100 μm thinner. It has been found that these minor processing steps alone are sufficient to significantly reduce the stresses in the area of the surface and also to shorten the processing time during milling.

The base body, including the bending spring elements, is preferably made of aluminum or a suitable alloy. The chemical composition of the solvent must be matched to the material of the base body, just like the temperature of the solvent, the concentration of the solvent and the exposure time, i.e. the removal time. Aluminum has proven itself for base bodies of weighing sensors.

After immersion in the chemical solution in the area of the bending spring joints, the base body is preferably not mechanically reworked. However, it is common practice to rinse the base body or to dip it into one or several solutions to control or stop the chemical process or to free the component from non-soluble particles that have accumulated on the surface. With aluminum alloys, the latter step is usually carried out using nitric acid, also called pickling.

After machining, the base body should preferably only be reworked by the contact with liquid, in particular by the dipping into liquid, i.e. into the chemical solution and possibly other solutions, or by spraying, so that no further stresses enter the component.

Optionally, the chemical solution may flow along the milled base body by means of a generated flow, to ensure that a certain amount of chemical solution flows across the surface to be treated in a certain period of time. The flow may be generated, for example, by a pump, air bubbles or by swiveling the container holding the solution and the base body.

It has been found that an exposure time at room temperature in a 20% NaOH solution (sodium hydroxide) of at least 10 minutes, in particular at least 30 minutes, during which the milled base body is immersed in the chemical solution, is usually sufficient. However, according to the tests carried out, an exposure time of more than 60 minutes is not necessary to achieve further significant improvements in properties.

In tests, a further significantly improved reduction of the stresses and shortening of the immersion time could be achieved by heating the chemical solution 20% NaOH solution (sodium hydroxide) to a temperature of 40° C. to 70° C. when the base body is immersed therein for 1-10 minutes. However, these slightly elevated temperatures are already sufficient to achieve a so-called ageing effect as a side effect, i.e. an ageing or tempering effect occurs in the area of the surface and internal material areas.

An optional subsequent drying process at a temperature also increased to at least 50° C., in particular for a period of 20 to 60 minutes, also has a positive effect. This additionally reduces internal stresses in the material.

A further option is to immerse areas of the base body in the chemical solution for different lengths of time, i.e. to allow them to be processed by the chemical solution for different lengths of time. This applies in particular to the areas of the bending spring joints. For example, based on the installation condition, the bending spring joints of arms at the top can be processed longer or shorter than the bending spring joints of arms below them in the same parallelogram guide. In addition, if several arms or parallelogram guides are provided on a base body, these can of course remain immersed in the chemical solution for different lengths of time. This makes it possible, on the one hand, to achieve different thicknesses of the bending spring joints and, on the other hand, an area which is difficult for a milling cutter to access can, for example, remain thicker after milling, but then remain in the chemical solution for longer and be reworked.

It is also possible to cover areas so that no chemical solution reaches certain places which are not to be treated or are to be treated for a shorter time than other areas in the chemical solution.

The method according to the invention may be fully automated, i.e. corresponding fully automatic handling systems pick up the base body and transfer it into the solutions and remove it from the solutions again. For example, the base body is first treated with NaOH and then pickled.

Where reference is made to different processing times in the chemical solution, this does not include the time required to move the base body into and out of the liquid, because then an upper section would always be in the liquid for a shorter time than a lower section of the base body. For the different treatment times, it is therefore necessary that the otherwise preferably continuous speed for introduction into and removal from the liquid becomes discontinuous, or that the base body remains at a certain reception depth before it is immersed even deeper or, if necessary, turned and reintroduced into the liquid at a different point.

It is not only possible to immerse the base body alone in the chemical solution, but at least one additional component (which is part of the balance to be manufactured with the corresponding base body) may also already be attached thereto when it is immersed in the chemical solution. This additional component is either covered or not immersed in the solution or is not soluble (different material). However, if required, it may change the stress of the base body minimally, so that it may be advantageous to have an already mounted assembly, of which the base body is a part, mounted on the base body during processing by the chemical solution. Already mounted assemblies are, for example, mechanical stops or locks.

The invention further relates to a base body of a weighing sensor, which is manufactured in accordance with the method according to the invention.

### BRIEF DESCRIPTION OF THE DRAWINGS

Further features and advantages of the invention will become apparent from the following description and the following drawings, to which reference is made and in which:

FIG. 1 shows a side view of a base body of a high-precision balance, manufactured by the method according to the invention, in accordance with a possible design,

FIG. 2 shows a top view of the base body according to FIG. 1, and

FIG. 3 shows a device by means of which the method according to the invention is carried out.

### DETAILED DESCRIPTION

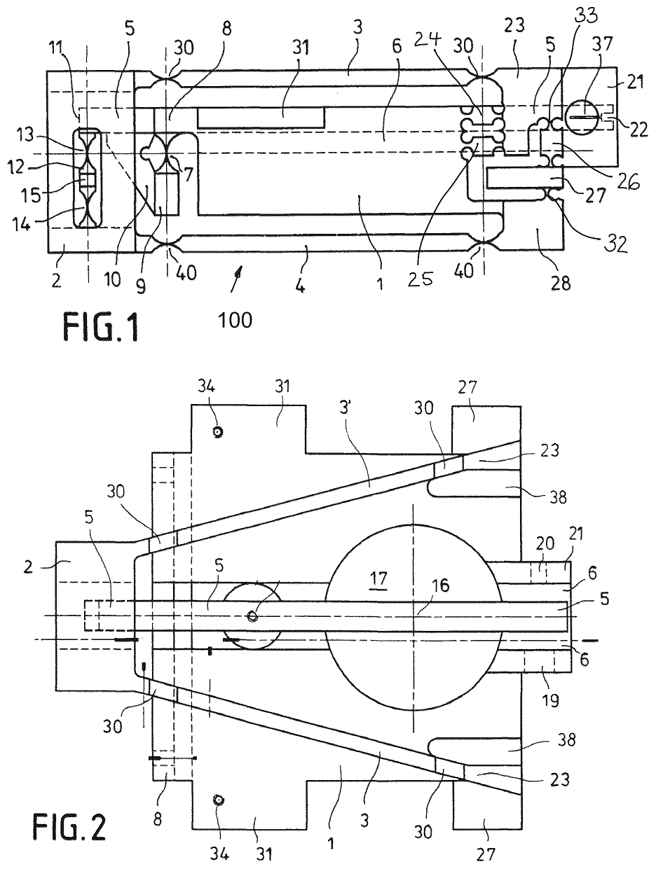

FIGS. 1 and 2 show a monolithic base body 100 of a weighing sensor of a high-precision balance, which is milled out of a metal block.

The base body 100 has a plurality of sections, namely a carrier 1, a load sensor 2 and a plurality of pivotally mounted arms 3 and 4, wherein behind the upper arm 3, a further upper arm 3′ is provided, which is identical thereto and can be seen in FIG. 2, just as an identical further lower arm 4′ is provided, which is hidden behind the lower arm 4 in FIG. 1. These arms 3, 3′, 4 and 4′ are also referred to as links. For example, the upper and lower arms can each be V-shaped, see FIG. 2.

The parallelogram guide for the load sensor 2 is formed by the overall four arms 3, 3′, 4 and 4′.

The four arms 3, 3, 4 and 4′ are each mounted by a bending spring joint 30, 40 at the opposite ends, wherein they merge integrally into the adjacent sections of the base body 100 and are produced, for example, by milling. Accordingly, the bending spring joint 30, 40 is also an integral part of the base body 100.

A weighing pan (not shown) can be attached directly or indirectly to the load sensor 2.

The base body 100 also includes a transmission lever 5, which is separated from the carrier 1 by a groove 6. Furthermore, one or more additional bending spring joints 7 are provided for mounting the transmission lever 5 on the carrier 1.

The bending spring joints 7 merge at the top into a cantilevered area 8 of the carrier 1 and at the bottom into a crossbeam 9. The transmission lever 5 extends downwards from the area 8. The connection between a front end 11 of the transmission lever 5 and the load sensor 2 is realized by means of a coupling element 12, which is also integrated in the metal block. This coupling element 12 is connected in a hinged manner to the end 11 by means of a bending spring joint 13 and to the lower part of the load sensor 2 by means of a further bending spring joint 14.

A further bending spring joint 15 which is perpendicular to the other two bending spring joints 13 and 14 is located in the center of the coupling element 12, so that a decoupling between the load sensor 2 and the transmission lever 5 is achieved in both directions.

To complete the weighing sensor, a coil (see coil center point 16) must be attached to the transmission lever 5 from below, and a cylindrical permanent magnet must be inserted from below into an opening 17 provided for this purpose (see FIG. 2) and be fixed there.

A slot 37 of an optical position sensing means is also incorporated in the transmission lever 5. A round hole 20 is provided in a projection 21 on the carrier 1 for an LED of the optical position sensing means, and a hole 19 is provided on the opposite side of the projection 21 for a differential photodiode of the optical position sensing means.

A wide slot 22 at the end of the transmission lever 5 serves to limit the movement of the transmission lever 5. A horizontal pin, not shown, mounted eccentrically in the projection 21, engages through this slot 22 and limits the movement of the transmission lever 5 to the difference between the slot width and the diameter of the pin.

Also integrally milled out of the base body 100 is a device for reducing the effects of off-center loads. A fastening point 23 of the upper arm 3, 3′ is connected to the rest of the carrier 1 by two horizontal arms 24 and 25, which form a parallelogram guide.

The fastening point 23 is separated from the rest of the carrier 1 by a slot 38. The area of the fastening point 23 is supported by a vertical web 26 and a corner load setting lever 27 on an area 28 which is firmly connected to the carrier 1.

Due to the lateral offset of bending spring joints 32, 33, tilting of the corner load setting lever 27 results in a slight vertical movement of the fastening point 23 for the upper arms 3, 3′. By adjusting the vertical distance of the arms 3, 3′, 4 and 4′ in the area of the carrier-side fastening point thereof, it is possible to adjust the parallelogram guide they form in terms of corner load freedom.

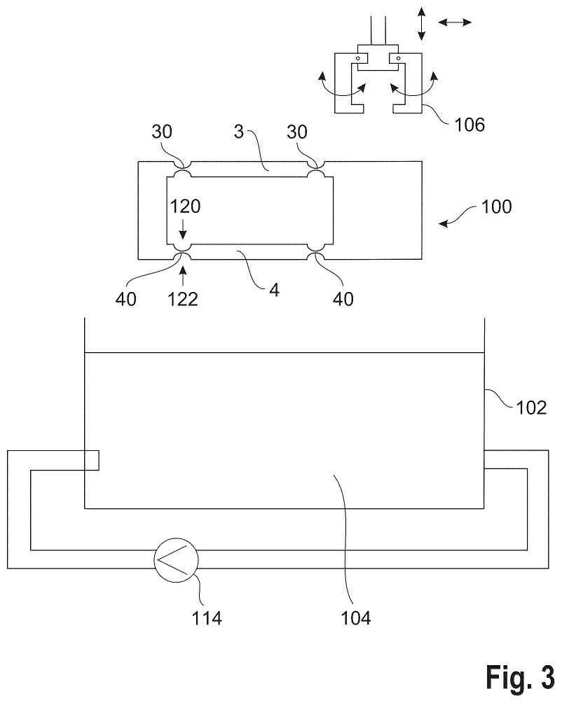

FIG. 3 represents the base body 100 in a very stylized and simplified form.

A container 102 containing a chemical solution, in this case a caustic solution 104, is also illustrated.

One example of a caustic solution is a 20% NaOH solution (aqueous sodium hydroxide).

The base body 100 is usually washed and degreased after processing, in particular milling, without being further mechanically processed, and can then be immersed fully automatically, either partially or completely, in the solution 104 by a gripper 106.

The chemical solution 104 is heated to above 20° C., preferably to a range of 40° C. to 70° C., while the base body 100 is immersed therein.

The time during which the base body 100 is in the solution and undergoes surface removal due to the solution varies depending on which chemical solution is selected and how much removal is desired.

In particular, a material removal of 2 to 50 μm should occur on the flat sides 120, 122 of the bending spring joints 30, 40.

To allow the chemical solution to flow into all areas of the base body 100, a pump 114 can be provided which generates a flow inside the container 102. However, this is not absolutely necessary.

It has been found that the base body 100 should usually be immersed in the chemical solution 20%-NaOH at elevated temperatures for at least one minute, and in particular for at least ten minutes, to have undergone sufficient surface treatment.

When it is immersed, only part of the base body 100 can enter the chemical solution 104, so that it is also possible to already mount an additional component, such as the coil, on the base body 100 when it is immersed in the solution in sections.

If, for example, threads have already been cut, which should be the case, these can be covered, for example with a plug, so that no chemical solution penetrates them.

It may also be advantageous if, for example, the bending spring joints are treated to different degrees by the chemical solution, for example the bending spring joints 30 and 40. Then the base body 100 is first only partially immersed in the solution 104, namely in the area of the bending spring joints 40. The gripper 106 then remains in this position for a certain period of time before the bending spring joints 30 are finally immersed.

After the base body 100 has been removed from the chemical solution, the base body 100 must be pickled, e.g. either immersed in another solution to rinse off the caustic solution or sprayed off to stop the etching process.

Subsequent mechanical processing is preferably no longer carried out.

However, the base body 100 is dried after rinsing at elevated temperatures of more than 50° C. for a period of 20-60 minutes, for example, which also reduces internal stresses in the material.

Even though only the bending spring joints 30 and 40 have been described here with regard to the treatment by the chemical solution 104, it is understood that, of course, all or some of the other flectors described and the arms thereof can also be treated in the same way.

1-15. (canceled)

16. A method of manufacturing a base body of a weighing sensor of a balance, characterized by the following steps:
A) a base body or part of a base body is machined out of a monolithic metal block, forming at least one arm which is connected to the rest of the metal block via integral bending spring joints in the form of thin spots, and
B) the machined base body or the part of the base body is exposed at least at the bending spring joints to a chemical solution, which causes a material removal at the bending spring joints.

17. The method according to claim 16, wherein the entire base body or a partial area of the base body is exposed to a chemical solution.

18. The method according to claim 17, wherein the entire base body or a partial area of the base body is immersed in the chemical solution or is sprayed with the chemical solution.

19. The method according to claim 16, wherein the chemical solution etches surface at least in an area of the bending spring joints.

20. The method according to claim 16, wherein in step B), at least a defined material removal of 2-50 μm occurs on flat sides of the bending spring joints.

21. The method according to claim 16, wherein the chemical solution is heated above 20° C. when the base body is immersed.

22. The method according to claim 21, wherein the chemical solution is heated in a range of 40° C. to 70° C. when the base body is immersed.

23. The method according to claim 16, wherein the base body is made of aluminum or of an aluminum alloy.

24. The method according to claim 16, wherein the base body, after being acted upon with the chemical solution, is no longer mechanically reworked in an area of the bending spring joints.

25. The method according to claim 16, wherein the base body, after machining, is reworked exclusively by contact with liquid.

26. The method according to claim 16, wherein the chemical solution flows along the base body machined out by means of a generated flow.

27. The method according to claim 16, wherein the base body machined out is received in the chemical solution for 30 seconds to 10 minutes.

28. The method according to claim 27, wherein the base body machined out is received in the chemical solution for at least 2 minutes.

29. The method according to claim 16, wherein the chemical solution is heated to a temperature of 40° C. to 70° C. when the base body is acted upon with the chemical solution.

30. The method according to claim 16, wherein areas are processed in the chemical solution for different lengths of time.

31. The method according to claim 30, wherein bending spring joints are processed in the chemical solution for different lengths of time.

32. The method according to claim 16, wherein at least one additional component, which is part of the balance to be manufactured, is mounted on the base body when it is immersed in the chemical solution.

33. The method according to claim 16, wherein the base body is dried at a temperature of at least 50° C. after removal of the chemical solution.

34. The method according to claim 16, wherein the base body or part of the base body is milled out of the monolithic metal block in step A).

35. A base body manufactured in accordance with the method according to claim 16.
